(19) United States
(12) Patent Application Publication
(10) Pub. No.: US 2026/0161589 A1
(43) Pub. Date: Jun. 11, 2026

(54) Resilient Optical Interconnect Technologies For Large-Scale Computing

(71) Applicant: Google LLC, Mountain View, CA (US)

(72) Inventors: Xiang Zhou, Santa Clara, CA (US); Cedric Fung Lam, San Carlos, CA (US); Hong Liu, Palo Alto, CA (US)

(21) Appl. No.: 18/977,221

(22) Filed: Dec. 11, 2024

(51) Int. Cl. G06F 13/36

(52) U.S. Cl. CPC G06F 13/36; G06F 2213/40

(57) ABSTRACT

An interconnect network includes processing nodes having regular communication lanes and at least one redundant protection communication lane. The redundant protection communication lane communicates data from the processing node when a failure occurs in a regular communication lane. Optical modules produce optical data signals over a group of ICI links Optical circuit switches in communication with the ICI links direct data between communicating processing nodes. A protection switch in communication with at least one protection communication lane. Processing nodes may include TPUs grouped as building blocks. Each optical module separates communication lanes in the optical module according to wavelength and interleaves the communication lanes to each ICI link receiving only one communication channel per optical module. A processing node can be configured to transmit a portion of the processing node's data communication via at least one protection communication lane.

### BACKGROUND

Large scale computing systems use high speed networking components including optical links, optical circuit switches, optical modules and chip to module (C2M) serializer/deserializer (SerDes) communication lanes. As these systems scale, the number of interconnections increases. With the number of components increasing, the likelihood that some of those components will fail also increases.

Large language models (LLM) use machine learning to receive request via natural language and to respond in kind. LLMs use machine learning (ML), which involve networks trained with massive amounts of information. Processing this information requires a very large number of processing nodes. Typically, training LLMs involves using tensor processing units (TPUs) on the order of thousands or tens of thousands. The many processing nodes must communicate with each other through an interconnect network. To maintain speed and efficiency in training LLMs, both computing power of the processing nodes and communication bandwidth through the interconnect network are crucial. Further, the ML workloads associated with LLMs require synchronous operation of all processing nodes. Thus, any failures in processing nodes or interconnect network components may result in job interruption.

Processing nodes can be arranged in pods. As the number of processing nodes in a pod increases, the chances of failure of interconnect components also increases. There is a need for resilience and redundancy in interconnect networks like those used to perform ML training in applications such as LLMs.

### BRIEF SUMMARY

The technology is generally directed to an interconnect network providing redundant protection SerDes lanes from each processing node. The protection lanes can be used to communicate data that could not be otherwise transmitted due to a failure of a component in the regular interconnect network.

An interconnect network in a computing system includes a plurality of processing nodes the processing nodes comprising a plurality of regular communication lanes and at least one redundant protection communication lane in communication with the processing nodes, the redundant protection communication lane providing data communication to the computing system from the processing node when a failure occurs in one of the regular communication lanes. The regular communication lanes and the at least one protection lane comprise SerDes lanes. A number of optical modules in communication with the processing nodes produce an optical data signal communicating data from the processing nodes to the computer system.

A group of ICI links in communication with the optical modules transmit the optical data signals from the processing nodes to the computer system. Optical circuit switches in communication with the ICI links direct data between communicating processing nodes.

To remediate possible component failures in the interconnect network, a protection switch in communication with at least one protection communication lane is associated with each processing node. Processing nodes may include TPUs. Processing nodes can be grouped as building blocks, a building block comprising a pre-determined number of processing nodes.

A controller in each optical module separates communication lanes in the optical module according to wavelength interleaves the communication lanes relative to the ICI links, such that an ICI link receives only one communication channel from an associated optical module.

The processing node controller further enables the processing node to transmit a portion of the processing node's data communication via at least one protection communication lane. A processing node of the plurality of processing nodes may have exactly one protection lane or one protection lane for each dimension in the computer system.

Electrical circuitry in communication with the processing node and a number of optical modules directs a portion of the communication lanes of the processing node to a first optical module and directs a second portion of the communication lanes of the processing node to a second optical module.

A processing node controller associated with each processing node can instruct the processing node to operate in a degraded mode when a failure occurs in a regular communication lane and enable the processing node to transmit a portion of the processing node's data communication via the at least one protection communication lane.

A method of interconnecting processing components in a computing system includes establishing a first set of regular communication lanes between a group of processing nodes and one or more inter-chip interconnect (ICI) links and providing at least one other protection communication lane between one processing node and one of the one or more ICI links. An optical module includes a number of optical lanes based on a wavelength of an optical signal. A controller of the processing node interleaving the optical lanes so that a particular optical lane is in communication with a corresponding ICI link, wherein a corresponding ICI link receives the particular optical lane from optical modules corresponding to processing nodes.

The processing nodes perform network communications in a degraded mode on a condition that one of the regular communication lanes fails, wherein a fraction of a capacity of a normal operating mode is routed to remaining healthy regular communication lanes. When the processing node is operating in a degraded mode an embedded router of the processing node routes the remainder of the capacity of the normal operating mode not being routed to the remaining healthy regular communication lanes to the at least one other redundant protection communication lane.

### BRIEF DESCRIPTION OF THE DRAWINGS

FIG. 1A is a diagram of an interconnect system according to the described technology.

FIG. 1B is a diagram of an interconnect system illustrating a failure of a component of the interconnect system.

FIG. 2 is a diagram of an interconnect system with redundant protection lanes according to aspects of the described technology.

FIG. 3 is a diagram of an interconnect system with redundant protection lanes according to aspects of the described technology.

FIG. 4 is a diagram of a spatial interleaving of communication lanes in an interconnect system according to aspects of the described technology.

FIG. 5 is a diagram illustrating the operation of a degraded mode based on failure of one optical lane according to aspects of the described technology.

FIG. 6A is a diagram of an interconnect system with redundant protection lanes with no component failures.

FIG. 6B is a diagram of the interconnect system of FIG. 6A illustrating a component failure according to aspects of the described technology.

FIG. 7 is a diagram of electrical shuffling of communication lanes according to aspects of the disclosed technology.

FIG. 8 is a diagram of electrical shuffling of communication lanes according to aspects of the disclosed technology.

FIG. 9 is a block diagram of an example system according to aspects of the disclosure.

### DETAILED DESCRIPTION

A novel N+M protected optical interconnect technology is proposed to improve the resiliency of large scale computing against networking component failure such as the failure of optical circuit switches (OCSs), optical inter-chip interconnect links (ICI), optical modules or chip to (optical module) (C2M) serializer/deserializer (SerDes) lane failures. Four novel concepts are introduced to enable this capability at minimal cost and power. First, redundant protection for C2M SerDes lanes on a processing node basis is introduced. Second, a spatial sub-link coding technique enables the mapping OCS and optical link failures to a single wavelength or SerDes lane problem per module (or tensor processing unit (TPU)). This spatial interleaving technology can reduce the required number of protection SerDes lanes by a factor of 8. Third, a degraded operation mode is enabled to allow a processing node to operate on the remaining healthy lanes when a portion of the lanes fail. Finally, each processing node is configured to redistribute a portion of its capacity from normal SerDes lanes to the protection lanes when an OCS or an optical link failure is detected.

LLM based machine learning technologies are revolutionizing a number of industries. However, LLM training requires the use of a very large number of processing nodes organized as a computing pod. Typically, a pod may include thousands to tens of thousands of tensor processing units (TPU) or processing nodes. These processing nodes must communicate with one another through an interconnect network. Both the computing power of the processing nodes and the communication bandwidth of the interconnect network are critical for the speed and efficiency of LLM training. Moreover, LLM based ML workloads require synchronous operation of all the processing nodes, and any failure of processing nodes or interconnect network components can result in job interruptions. Further, the requirement for synchronous operations hinders the scalability of computing pods.

Scaling of processing nodes may be addressed by reconfigurable superpods that utilize OCS-based optical interconnect technology. Reconfigurable superpods can dynamically assemble computing pods on a per job basis from a large pool of processing nodes. Because the pool includes redundant processing nodes, the availability of healthy computer pods may be greatly improved.

But as the computing pod size increases, interconnection network component failures also emerge as a consequence for although the reconfigurable superpod introduces redundancy to the processing nodes, it does not introduce redundancy to the interconnect network. This is due to the fact that it is too challenging to introduce interconnect network redundancy without substantially increasing ML superpod cost. Introducing system-level redundancy to handle interconnection network components failure problems in reconfigurable superpods used in LLM training increases reliability and resiliency.

Software routing based technology has been proposed to improve the resiliency of superpod against OCS single-point failures, but this technology will result in significant inter-chip interconnect (ICI) bandwidth reduction as well as doubling the ICI latency, and the performance degradation is impracticable in view of LLM training requirements.

Another proposal to address the OCS single-point failure problem is to introduce 1+1 OCS protection. This requires double the required number of OCSs and optical links, but also substantially increases the optical link loss, making optical transceiver design more challenging.

The described technology introduces four novel concepts to enable M+N protected superpods, where M is the number of regular SerDes lanes, and N is the number of additional, protection SerDes lanes available for use. The N+M protected superpod not only eliminates the OCS single-point failure problem facing the reconfigurable superpod, but also greatly improves the resiliency against optical and electrical link failures. With this new technology, there will be no performance and latency degradation when operating at the resilient mode, the additional cost and power overhead is relatively small. For example, for a 5-dimensional Torus superpod with each TPU having 80 SerDes lanes, only one additional protection SerDes lane per TPU is needed to protect optical ICI link failures (if no more than one link failure per building block.) This additional SerDes lane can also protect against single OCS failures within a group of OCSs of one specific dimension, as well as all optical module problems caused by a single lane failure within the module. If one protection SerDes lane per dimension is provided (i.e., 5 protection SerDes lanes per TPU), protection can be provided for up to 5° C. S failures (one per dimension), in addition to protecting against all optical module-related problems.

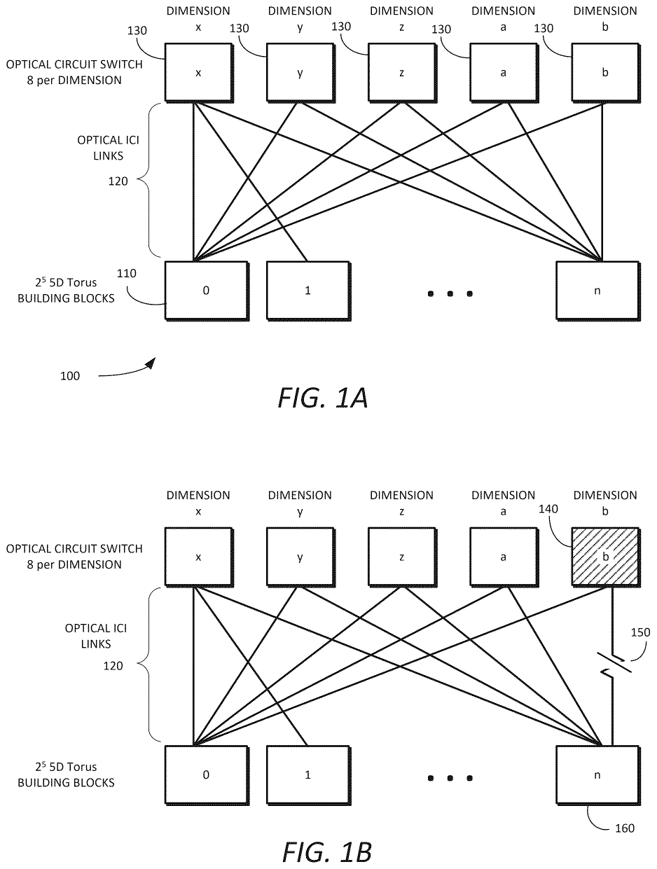

FIG. 1A is a schematic illustration of a reconfigurable superpod 100 is shown, where a 5-dimensional (5D) Torus topology using 2×2×2×2×2 (32 TPUs, within one rack) as the building block 110 of the 5D superpod 100. It is assumed that each TPU has a total of 80 200 Gb/s SerDes lanes, with 16 SerDes lanes per dimension 130 (8 SerDes lanes per direction per dimension). For such a superpod 100, each 5D building block 110 has 10 external facing hyperplanes, denoted X+, X−, Y+, Y−, Z+, Z−, a+, a−, b+b−, where X, Y, Z, a and b denote the 5 dimensions 130, and + and − denote the direction of each dimension 130. For every building block, there are a total of 32 optical ICI links 120 (8 SerDes lanes per ICI link) per dimension 130 (2 Hyperplane per dimension, e.g., X+ and X−) that are connected to 8° C. Ss that are allocated to that dimension.

FIG. 1B is a schematic illustration of the reconfigurable superpod 100 of FIG. 1A illustrating a failure in a component of the interconnect network, such as an OCS or ICI link. A single OCS failure 140 will cause the loss of 4 ICI links for every building block, essentially bringing down the whole superpod. The blast radius of single optical link failure 150 is smaller than the OCS 140 because it only brings down a single building block 160, but the number of optical ICI links 120 is several orders of magnitude higher than that of the OCS, so optical link failures can still result in significant availability reduction of computing pods.

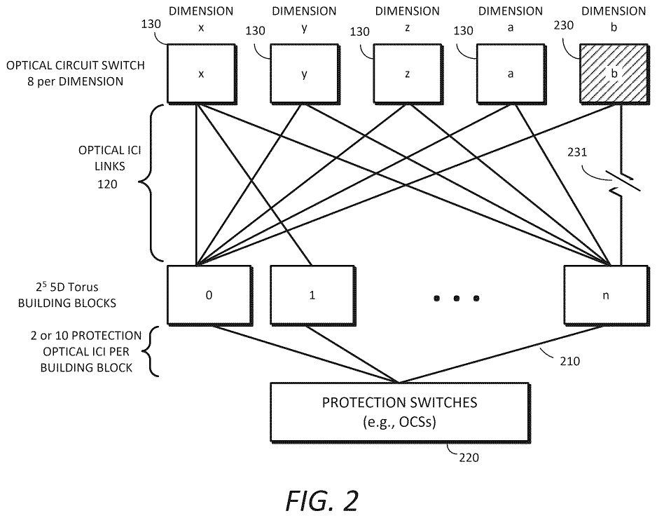

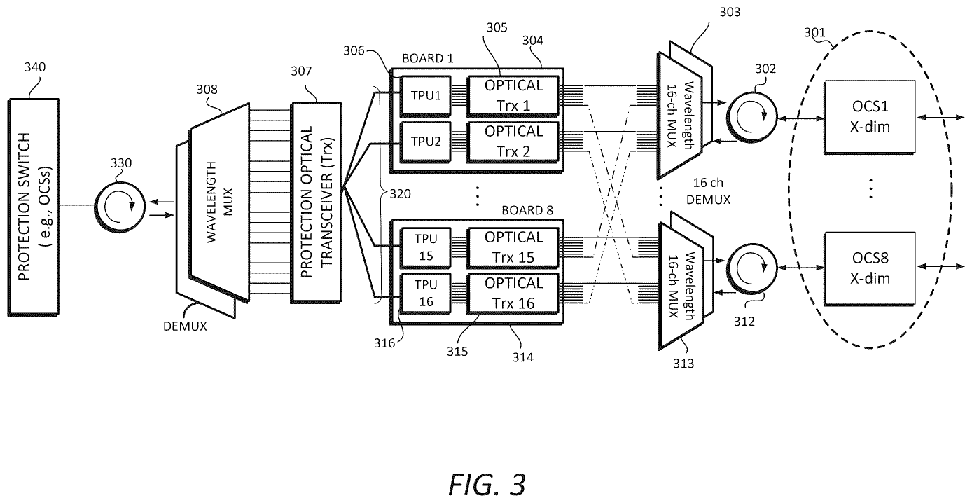

FIG. 2 is a schematic view of an interconnect network according to aspects of the described technology. To improve reliability and resiliency in interconnect networks, redundant protection C2M SerDes lanes 210 are introduced on a per-processing node basis. The protection SerDes lanes from each processing node are connected to a centralized protection switch 220. The protection switch 220 can be an OCS (preferably for our reconfigurable superpod), but it can also be an electrical circuit switch or an electrical packet switch. Regarding the required number of protection SerDes lanes 210, it can be simple 1 per processing node (TPU) or more than 1 such as a 1 per dimension 130, 230 for each TPU. For an example 5D superpod with 80 200 Gb/s SerDes lanes per TPU, 1 protection SerDes lane per TPU can protect 1 optical link failure 231 per building block. It is also able to protect a single OCS failure 230 from one dimension having 8 OCSs. IF the protection SerDes lanes 210 are increased to one per dimension per TPU, i.e., 5 total protection lanes per TPU, all single OCS and single optical link failures (per dimension per building block) can be protected. To reduce the required number of protection OCSs 220 and cross-rack protection ICI links 210, a single bidirectional protection ICI link may be used to transport all the protection capacity for one hyperplane of the building block as shown in FIG. 3.

FIG. 3 is a schematic diagram of a dimension of a reconfigurable superpod according to aspects of the described technology. To reduce the required optical TRx module number, flyover copper cable based low-loss C2M channel interconnects 320 may be used to have one optical module 307, which typically has 8 optical lanes, being shared by more than one PCB board 307, 314. For example, if each single PCB board hosts 2 TPUs 306, 316 and one protection SerDes lane per TPU 306, 316, up to 8 protection lanes from 4 PCB boards 304, 314 can be connected to a single 8-lane optical module 307.

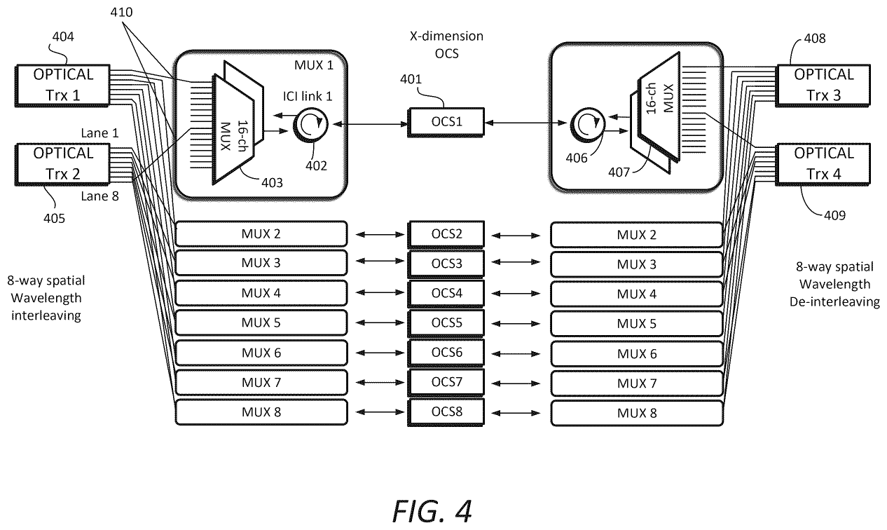

For each TPU processing node 306, 316 regular SerDes lanes are connected to regular optical modules 305, 315. The optical modules 305, 315 are connected through ICI links 302, 312 and mux/demux 303, 313 to the OCSs for the dimension 301. The optical modules may interleave the wavelength separated signals forwarding the different wavelengths to corresponding ICI links 302, 312. Interleaving the signals can reduce the effect of component failures in the interconnect network as will be described in more detail below with regard to FIG. 4. In addition to the regular communication lanes from optical modules 305, 315, additional protection SerDes lanes 320 are provided on a per processing node (TPU) 306, 316. The protection lanes 320 are connected to protection optical module 307. The optical signals are multiplexed in mux/demux 308 and connected to protection ICI link 330 and directed to protection switch 340. The interconnect network provides two paths for data produced by the processing nodes 306, 316. A first regular path passes through regular optical modules 305, 315 to switches 301. A protection pathway is defined from processing nodes 306, 316 to protection optical module 307 to protection switch 340.

FIG. 4 is a schematic view of an interconnect network with spatial interleaving according to aspects of the described technology. The described technology provides for spatial (convolutional) interleaving, or more generally, sub link-grade spatial (wavelength or SerDes lane-grade) coding technology. The key concept for wavelength-grade link coding technology is to rearrange colored optical lanes (wavelengths) of the optical modules 404, 405 on the same hyperplane of the building block in a way that each optical ICI link 401 only includes a single optical lane (wavelength) 410 from each optical module 404, 405. For the exemplary spatial wavelength-interleaving technique shown in FIG. 3 and FIG. 4, there are 8 odd-numbered optical modules and 8 even-numbered optical modules for each of the 10 hyperplanes of the 5D building block. Both the odd and even numbered optical modules have 8 colored lanes/wavelengths, but the used wavelength groups are different (so the two wavelength groups can be wavelength multiplexed into a single cross-rack optical ICI link). Convolutional wavelength interleaving is performed separately for the two wavelength groups. For each wavelength group, the wavelength no. 1 through 8 of optical module 1 404 is encoded into the ICI link 402 no. 1 through 8 420, respectively, and the wavelength no. 1 through 8 of optical module 2 405 is encoded into the ICI link no 2, 3, 4, 5, 6, 7, 8, 1, respectively. The same interleaving principle can be applied to the other 6 optical modules. For example, the wavelength no 1. through 8 of optical module no. 8 are encoded into the ICI link no. 8, 1, 2, 3, 4, 5, 6, 7, respectively.

The convolutional interleaving is performed at the transmitter side, and the two convolutionally interleaved wavelength groups are then combined by a wavelength multiplexer 403 into a single cross-rack ICI link 402 connecting to an OCS 401 of that dimension. At the receiver side, an inverse operation called de-interleaving is performed to recombine the 8 lanes/wavelengths originated from the same optical module into the receiver (peering) optical module 408, 409 by demux 407 connected to ICI link 406. With this novel spatial wavelength-interleaving technique, the failure of any single OCS or any single optical link (within one dimension of each building block) will only result in the single lane/wavelength failure problem on a per module basis. As will be discussed in detail below, performance degradation caused by the single lane/wavelength failure can be completely recovered by operating the impacted module in a degraded link mode carrying ⅞ original capacity (the third new concept), while routing the remaining ⅛ original capacity into the protection routes using the embedded TPU ICI router on the per TPU basis.

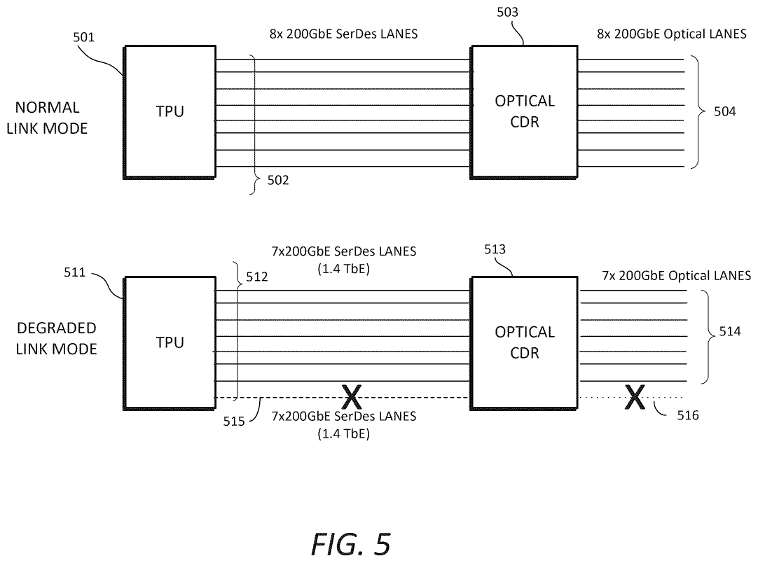

FIG. 5 is a block diagram for operating a processing node in a degraded state according to aspects of the described technology. In a normal mode each processing node TPU 501 has 8 regular SerDes lanes 502 connected to the optical module 503 producing 8 optical lanes 504. The optical module 503 and the TPU 501 C2M IO (normal SerDes) 502 may be operated in a degraded mode when one optical lane/wavelength 516 or one normal SerDes lane 515 fails by leveraging the remaining healthy lanes 512, 514. For example, if each optical module 513 has 8 optical lanes carrying 1.6 Tb/s (8×200 Gb/s) capacity at the normal state only ⅞ of the original capacity (7×200 Gb/s) is routed into the 7 healthy optical lanes 514 when one optical lane 516 fails. The same principle applies for the case of one 515 of 8 SerDes lanes 502 fails in the chip to module (C2M) channel.

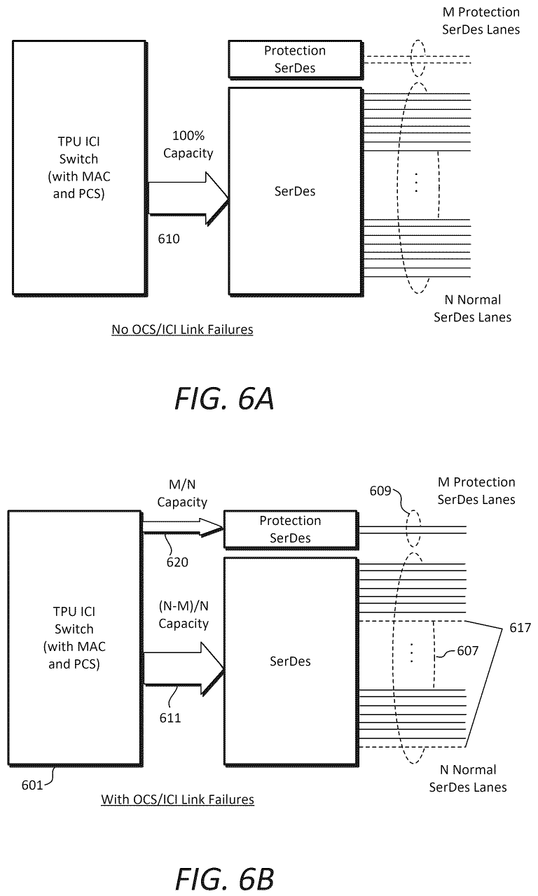

FIGS. 6A and 6B are schematic views of an interconnect network according to aspects of the described technology. The disclosed technology can leverage the embedded TPU switch/router on each TPU to redistribute a portion 620 of its original capacity 610 into the protection routes 609. The remaining capacity 611 is communicated through regular SerDes lanes 603. This redistribution occurs on a per-TPU basis when a predetermined ICI network failure mode 617 is detected, for example, through an ICI link-level monitoring system.

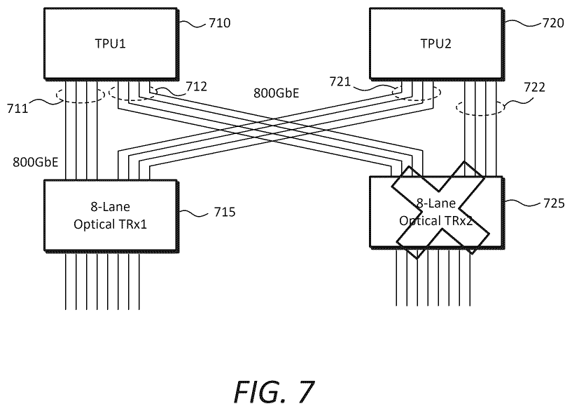

FIG. 7 is a schematic view of a process of electrical shuffling of SerDes lanes in an interconnect network according to aspects of the described technology. The disclosed technology can protect OCS and optical link failures. It can also protect optical module failures caused by single optical lane failures. To protect all optical module related failure problems, generally it is necessary for the number or protection SerDes lanes (per TPU) to match the number or optical lanes. For example, for the typical optical module having 8 optical lanes, 8 protection SerDes lanes per TPU are needed. But the required number of protection SerDes lanes can be reduced by a board-level electrical shuffling technology as shown in FIG. 7, where a two-way electrical shuffling is shown as an example. A controller function block configured to follow the optical module and to provide control of the SerDes lanes from the processing node to the optical module. From FIG. 7 one can see that with the use of two-way electrical shuffling, the required number of protection SerDes lanes per TPU can be reduced by half, because the failure of an 8-lane optical module only results in a 4 lane capacity loss 712, 722 from each TPU 710, 720. With the addition of this two-way electrical shuffling technology, all OCS, optical link, and optical module failures can be protected by using five protection SerDes lanes per TPU for the example 5D Torus superpod shown in FIG. 2. In two way electrical shuffling, TPU 710 directs its SerDes lanes 711, 712 to two different optical modules 715. 725. A first group of four SerDes lanes 711 is directed to optical module 715 and a second group of four SerDes lanes 712 are directed to optical module 725. Likewise, TPU 720 directs its SerDes lanes 721, 722 to two different optical modules 715. 725. A first group of four SerDes lanes 721 is directed to optical module 715 and a second group of four SerDes lanes 722 are directed to optical module 725. In a scenario where optical module 725 fails, only four lanes of each TPU 710, 720 is affected.

For cases where electrical interleaving/shuffling across multiple TPU PCB boards is feasible, for example, lower-loss flyover copper cables are used for C2M channel connections.

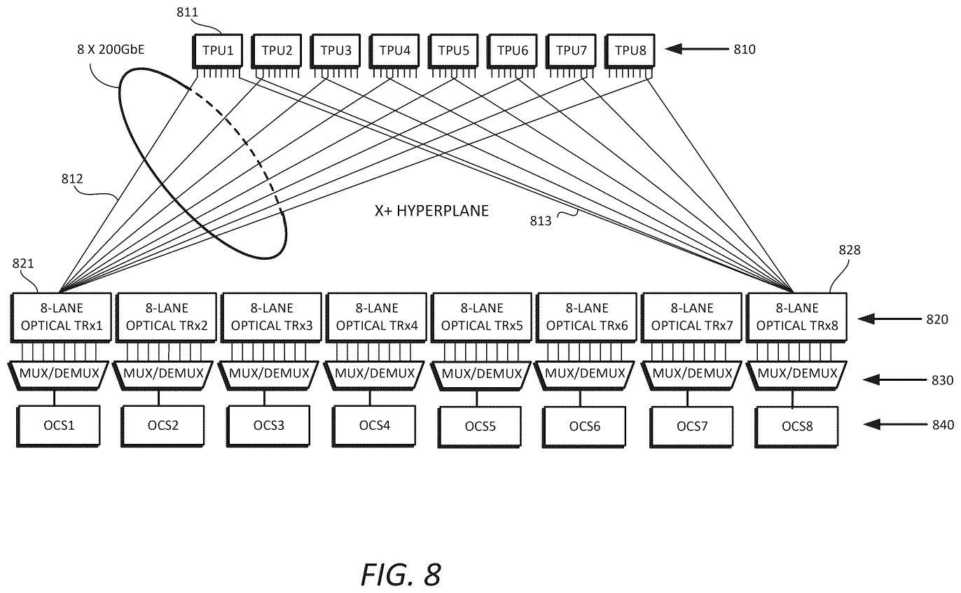

FIG. 8 is a schematic view of a process of electrical shuffling of SerDes lanes in an interconnect network according to aspects of the described technology. Where the example shown in FIG. 7 illustrates a two-way electric shuffling, the required number of protection SerDes lanes per TPU may be further reduced by implementing an 8 way electrical shuffling as shown in FIG. 8. For a group of 8 TPUs 810. Each TPU 810 has 8 SerDes lanes connecting the TPUs 810 to corresponding 8 optical modules 820. For clarity, each TPU 810 only shows connection of 2 of the 8 SerDes lanes to the optical modules 820.

Using TPU 811 as an example, SerDes lane 1 812 is connected to optical module 821 and SerDes lane 8 813 is connected to optical module 828. Similar to the convolutional interleaving described above in FIG. 3, the 8 way electrical shuffling interleaves the SerDes lanes in a similar manner. With reference to optical module 821, it may be seen that optical module 821 receives a single SerDes lane from each TPU 810. Thus, in the case of any optical module 810, ICI link 830 or OCS 840 will only result in one SerDes lane being affected per TPU 810. Accordingly, each TPU could compensate for an interconnect network failure with only one protection SerDes lane using the technique shown in FIG. 6B.

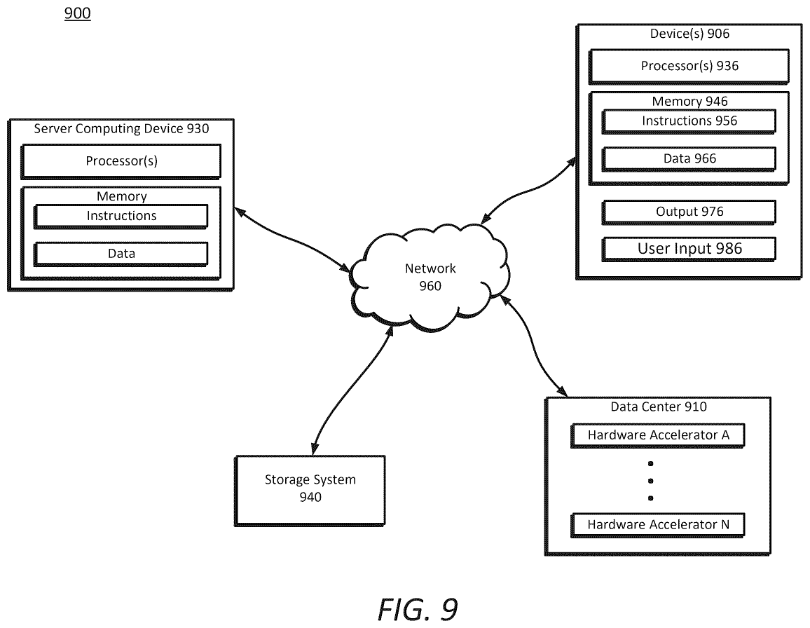

FIG. 9 illustrates an example system 900 in which the features described above may be implemented. It should not be considered limiting the scope of the disclosure or usefulness of the features described herein. In this example, system 900 may include device(s) 906, server computing device 930, storage system 940, and network 960.

Each device 906 may be a personal computing device intended for use by a respective user. The device 906 may include one or more processors 936, memory 946, data 966 and instructions 956. Each device 906 may also include an output 976, user input 986, and location sensor 996. By way of example only, devices 906 may be mobile phones or devices such as a wireless-enabled PDA, smartphones, a tablet PC, a wearable computing device (e.g., a smartwatch, AR/VR headset, smart helmet, etc.), a netbook that is capable of obtaining information via the Internet or other networks, or a smart home device, such as a home assistant, smart thermostat, smart doorbell, smart light, etc.

Memory 946 of device 906 may store information that is accessible by processor 936. Memory 946 may also include data that can be retrieved, manipulated or stored by the processor 936. The memory 946 may be of any non-transitory type capable of storing information accessible by the processor 936, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 946 may store information that is accessible by the processors 936, including instructions 956 that may be executed by processors 936, and data 966.

Data 966 may be retrieved, stored or modified by processors 936 in accordance with instructions 956. For instance, although the present disclosure is not limited by a particular data structure, the data 966 may be stored in computer registers, in a relational database as a table having a plurality of different fields and records, XML documents, or flat files. The data 966 may also be formatted in a computer-readable format such as, but not limited to, binary values, ASCII or Unicode. By further way of example only, the data 966 may comprise information sufficient to identify the relevant information, such as numbers, descriptive text, proprietary codes, pointers, references to data stored in other memories (including other network locations) or information that is used by a function to calculate the relevant data.

The instructions 956 can be any set of instructions to be executed directly, such as machine code, or indirectly, such as scripts, by the processor 936. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 936 may include any conventional processors, such as a commercially available CPU or microprocessor. Alternatively, the processor can be a dedicated component such as an ASIC or other hardware-based processor. Although not necessary, computing devices 906 may include specialized hardware components to perform specific computing functions faster or more efficiently.

Although FIG. 9 functionally illustrates the processor, memory, and other elements of devices 906 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 906. Accordingly, references to a processor or device will be understood to include references to a collection of processors, devices, or memories that may or may not operate in parallel.

Output 976 may be a display, such as a monitor having a screen, a touchscreen, a projector, or a television. The display 976 of the one or more computing devices 906 may electronically display information to a user via a graphical user interface (“GUI”) or other types of user interfaces. For example, as will be discussed below, display 976 may electronically display query results.

The user input 986 may be a mouse, keyboard, touchscreen, microphone, or any other type of input.

The devices 906 can be at various nodes of a network 960 and capable of directly and indirectly communicating with other nodes of network 960. Although one device is depicted in FIG. 9, it should be appreciated that a typical system can include one or more devices, with each device being at a different node of network 960. The network 960 and intervening nodes described herein can be interconnected using various protocols and systems, such that the network can be part of the Internet, World Wide Web, specific intranets, wide area networks, or local networks. The network 960 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 900 may include one or more server computing devices 930 having a plurality of computing devices, e.g., a load balanced server farm, that exchange information with different nodes of a network for the purpose of receiving, processing and transmitting the data to and from other computing devices. For instance, one or more server computing devices 930 may be a web server that is capable of communicating with the one or more client computing devices 906 via the network 960. In addition, server computing device 930 may use network 960 to transmit and present information to a user of one of the other computing devices 906.

Server computing device 930 may include one or more processors, memory, instructions, data, etc. These components operate in the same or similar fashion as those described above with respect to computing device 906.

According to some examples, the server computing device 930 may be connected over the network to a data center 910 housing any number of hardware accelerators. The data center 910 can be one of multiple data centers or other facilities in which various types of computing devices, such as hardware accelerators, are located. Computing resources housed in the data center can be specified for repeated results monitoring, including identifying repeated query results, or the like.

The server computing device 930 can be configured to receive queries from the client computing device 906 on computing resources in the data center 910. For example, the environment can be part of a computing platform configured to provide a variety of services to users, through various user interfaces and/or application programming interfaces (APIs) exposing the platform services. The variety of services can include identifying content responsive to the query, determining whether query results are repeated query results, or the like. The client computing device 906 can transmit input data associated with a query. The server computing device 930 can receive the input data and, in response, identify and provide for output query results. When identifying the query results, the server computing device 930 can generate a signature for the query results. The generated signature may be compared to other signatures associated with the query results and/or historical query signatures. Based on the comparison, the server computing device 930 can determine whether the query results are repeated query results. In examples where the query results are repeated query results, the server computing device 930 can enable one or more preventative measures.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. An interconnect network in a computing system, comprising:
a plurality of processing nodes the processing nodes comprising a plurality of regular communication lanes; and
at least one redundant protection communication lane in communication with the processing nodes, the redundant protection communication lane providing data communication to the computing system from the processing node when a failure occurs in one of the regular communication lanes.

2. The interconnect network of claim 1, wherein the regular communication lanes and the at least one protection lane comprise serializer/deserializer (SerDes) lanes.

3. The interconnect network of claim 2, further comprising:
a plurality of optical modules in communication with the plurality of processing nodes producing an optical data signal communicating data from the plurality of processing nodes to the computer system.

4. The interconnect network of claim 3, further comprising:
a plurality of inter-chip interconnect (ICI) links in communication with the plurality of optical modules transmitting the optical data signals from the plurality of processing nodes to the computer system.

5. The interconnect network of claim 4, further comprising:
a plurality of optical circuit switches (OCS) in communication with the plurality of ICI links directing data between the plurality of processing nodes.

6. The interconnect network of claim 5, further comprising:
a protection switch in communication with the at least one protection communication lane.

7. The interconnect network of claim 5, wherein the plurality of processing nodes are tensor processing units (TPUs).

8. The interconnect network of claim 5, the plurality of processing nodes grouped as building blocks, a building block comprising a pre-determined number of processing nodes.

9. The interconnect network of claim 4, further comprising:
a controller functional block following the plurality of optical modules, the controller performing:
separating communication lanes in the optical module according to wavelength; and
interleaving the communication lanes based on wavelength relative to the plurality of ICI links, such that an ICI link receives only one communication channel from an associated optical module.

10. The interconnect network of claim 9, the processing node controller further performing the step of:
enabling the processing node to transmit a portion of the processing node's data communication via the at least one protection communication lane.

11. The interconnect network of claim 1, wherein the plurality of processing nodes are connected in a multi-dimensional torus interconnect topology.

12. The interconnect network of claim 11, wherein the plurality of processing nodes are connected in a five dimensional (5D) torus interconnect topology.

13. The interconnect network of claim 1, further comprising:
a processing node of the plurality of processing nodes comprising exactly one protection lane.

14. The interconnect network of claim 13, further comprising:
a processing node of the plurality of processing nodes comprising exactly one protection lane per dimension in the multi-dimensional torus interconnect topology.

15. The interconnect network of claim 14, further comprising:
electrical circuitry in communication with the processing node and a plurality of optical modules, wherein the electrical circuitry directs a portion of the communication lanes of the processing node to a first optical module and directs a second portion of the communication lanes of the processing node to a second optical module.

16. The interconnect network of claim 1, further comprising:
a processing node controller associated with each processing node of the plurality of processing nodes, the processing node controller performing the steps of:
instructing the processing node to operate in a degraded mode when a failure occurs in a regular communication lane; and.
enabling the processing node to transmit a portion of the processing node's data communication via the at least one protection communication lane.

17. A method of interconnecting processing components in a computing system comprising:
establishing a first set of regular communication lanes between a plurality of processing nodes and one or more inter-chip interconnect (ICI) links; and
providing at least one other protection communication lane between one processing node of the plurality of processing nodes and one of the one or more ICI links.

18. The method of claim 17, further comprising:
in an optical module of the processing node, defining a plurality of optical lanes based on a wavelength of an optical signal;
in a controller, interleaving the plurality of optical lanes so that a particular optical lane is in communication with a corresponding ICI link, wherein a corresponding ICI link receives the particular optical lane from a plurality of optical modules of a plurality of processing nodes.

19. The method of claim 17, further comprising:
in the processing nodes, performing network communications in a degraded mode on a condition that one of the regular communication lanes fails, wherein a fraction of a capacity of a normal operating mode is routed to remaining healthy regular communication lanes.

20. The method of claim 19, further comprising:
in the processing nodes, on a condition that the processing node is operating in a degraded mode, routing within the processing node, the remainder of the capacity of the normal operating mode not being routed to the remaining healthy regular communication lanes to the at least one other redundant protection communication lane.

21. The method of claim 18, wherein the at least one other protection communication lane is routed to a corresponding protection optical circuit switch.
